(19) United States
(12) Patent Application Publication
(10) Pub. No.: US 2016/0175880 A1
(43) Pub. Date: Jun. 23, 2016

(54) GOLF CLUB PROTECTIVE COATING

(71) Applicant: NIKE, INC., Beaverton, OR (US)

(72) Inventors: Jamil Jacaman, Fort Worth, TX (US); Stephanie Beck, Fort Worth, TX (US); Michael Taylor, Granbury, TX (US); Matthew Plumb, Tigard, OR (US); Matt Daraskavich, Grapevine, TX (US)

(73) Assignee: NIKE, INC., Beaverton, OR (US)

(21) Appl. No.: 14/633,559

(22) Filed: Feb. 27, 2015

Related U.S. Application Data
(60) Provisional application No. 62/094,619, filed on Dec. 19, 2014.

(51) Int. Cl. B05D 1/02; B05D 3/00

(52) U.S. Cl. CPC B05D 1/02; B05D 3/007

(57) ABSTRACT

A method of preparing a plurality of golf clubs for a retail sale includes providing a plurality of golf clubs that includes at least a first golf club head having a first attribute and a second golf club head having a second attribute. A first liquid polymeric material that has a tint of a first color is applied to an outer surface of the first golf club head, and a second liquid polymeric material that has a tint of a second color is applied to an outer surface of the second golf club head. The first liquid polymeric material and the second liquid polymeric material are each solidified to respectively form a first polymeric coating across the outer surface of the first golf club head and a second polymeric coating across the outer surface of the second golf club head.

### CROSS REFERENCE TO RELATED APPLICATIONS

This application claims the benefit of priority from U.S. Provisional Patent Application No. 62/094,619, filed Dec. 19, 2014, which is hereby incorporated by reference in its entirety.

### TECHNICAL FIELD

The present invention relates generally to a protective coating that is applied to the head of a golf club.

### BACKGROUND

Golf clubs are formed through a variety of methods. Commonly, a golf club head is forged or cast and then machined or ground and polished to the requisite dimensions and desired aesthetic quality. In some designs, the metal used to form the club head is left untreated, or “raw-finished,” to allow the metal to corrode and achieve a dull and/or rusted outer surface. Some golfers view this as a preferential design.

A wedge-type golf club may have many design attributes that provide a versatility that is sought by consumers. In particular, the design of the sole and the rear surface of the club may permit the club face to have a variable loft angle simply by rotating the club along the shaft axis. The design attributes, however, are difficult to quantify, and thus are often only generally referenced using marketing terminology, which may not be easily distinguished or noticed by a consumer at the point of a retail sale.

### SUMMARY

A method of preparing a plurality of golf clubs for a retail sale includes providing a plurality of golf clubs that includes at least a first golf club head having a first attribute and a second golf club head having a second attribute. In one configuration, the first attribute is a first sole profile and the second attribute is a second sole profile.

A first liquid polymeric material that has a tint of a first color is applied to an outer surface of the first golf club head, and a second liquid polymeric material that has a tint of a second color is applied to an outer surface of the second golf club head. The process of applying the liquid polymeric material may include, for example, spraying the liquid polymeric material across the outer surface of the club head, or dip-coating the club head.

The first liquid polymeric material and the second liquid polymeric material are each solidified to respectively form a first polymeric coating across the outer surface of the first golf club head and a second polymeric coating across the outer surface of the second golf club head. The solidifying may include drying or curing, depending on the specific composition of the liquid polymeric material. Once solidified, the polymeric material may form a coating that has a thickness of about 0.1 mm to about 0.4 mm.

In one configuration, the method may further include providing a first polymeric strip on a surface of the first golf club head and providing a second polymeric strip on a surface of the second golf club head. Each polymeric strip may be placed on the respective golf club head such that a free end of the strip is on the hosel of the head, and a portion of the strip lies along the sole. The strip may have a tensile strength that is greater than a tensile strength of the polymeric coating. Additionally, the polymeric strip may include an indicia that corresponds to the respective attribute of the golf club head.

In one configuration, the method further includes packaging the plurality of golf clubs together with a key that correlates each of the first color and the second color with the respective first attribute and second attribute.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic front view of a wedge-type golf club.

FIG. 2 is a schematic rear view of a wedge-type golf club.

FIG. 3 is a schematic side view of a liquid polymeric coating being applied to an outer surface of a wedge-type golf club.

FIG. 4 is a schematic perspective view of a pull strip being used to remove a polymeric coating from a wedge-type golf club.

FIG. 5A is a schematic perspective view of a first wedge-type golf club having a first sole profile and a polymeric coating of a first color.

FIG. 5B is a schematic perspective view of a second wedge-type golf club having a second sole profile and a polymeric coating of a second color.

FIG. 6 is a schematic diagram of a method of manufacturing a golf club head.

### DETAILED DESCRIPTION

Referring to the drawings, wherein like reference numerals are used to identify like or identical components in the various views, FIG. 1 schematically illustrates a golf club 10 that includes a club head 12 mounted on the end of an elongate shaft 14. The shaft 14 may be gripped by a user and swung to impart a generally arcuate motion to the club head 12 for the purpose of impacting a golf ball.

The club head 12 includes a face 16 that is intended to contact the golf ball during a normal swing. The face 16 generally includes a plurality of parallel grooves 18 that are recessed into the club head 12 in a generally concave manner. As is commonly understood, the face 16 may be disposed at an angle to a vertical plane when the golf club 10 is held in a neutral hitting position. This angle may be generally referred to as the loft angle or slope of the club. Wood-type club heads (including hybrid woods) may most commonly have a loft angle of from about 8.5 degrees to about 24 degrees, while iron-type clubs may most commonly have loft angles from about 18 degrees to about 64 degrees, though other loft angles are possible and have been commercially sold. A particular subset of iron-type club heads, referred to as “wedges,” may generally have loft angles of from about 45 degrees to about 64 degrees. The present technology may be of particular importance to iron-type club heads, and more specifically to wedges.

The face 16 may generally separate a toe portion 20 of the club head 12 from a heel portion 22 of the club head 12. The heel portion 22 includes a hosel 24 that is operative to couple the club head 12 with the shaft 14. In one embodiment, the hosel 24 may include a free end 26 that defines an annular opening configured to directly receive the shaft 14. A plastic ferrule 27 may surround the shaft 14 and abut the hosel 24 to provide a smoother transition from the hosel 24 to the shaft 14. In other embodiments, the annular opening of the hosel 24 may receive an adjustable shaft adapter that, in turn, may receive the shaft 14.

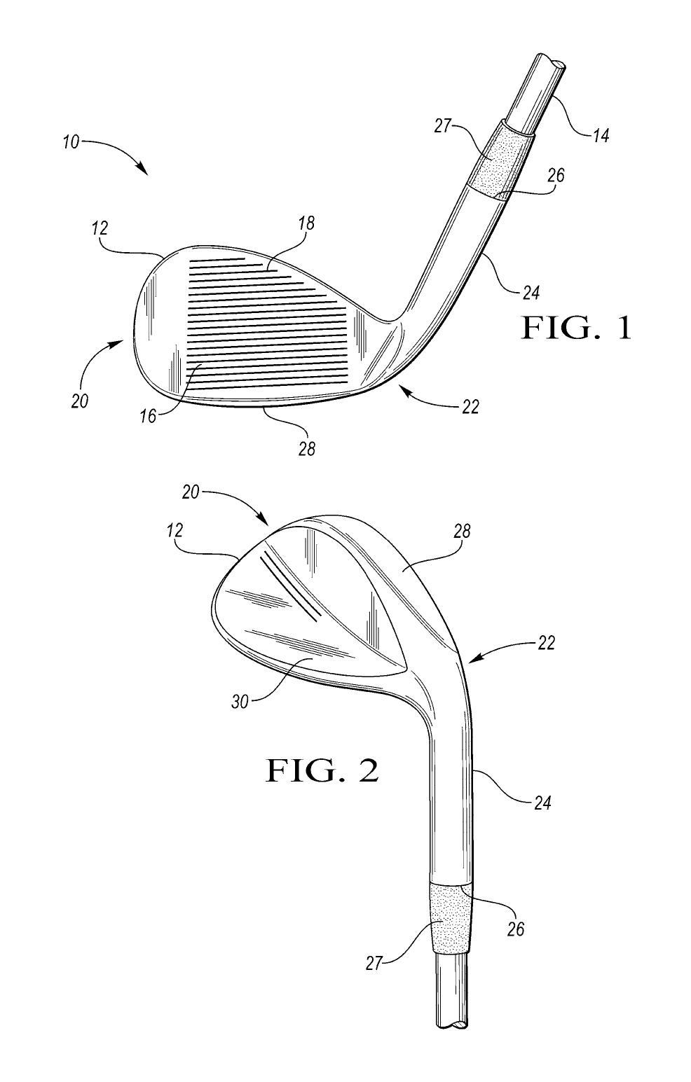

A sole 28 of the club head 12 may extend on an underside of the club head 12 such that the sole 28 contacts the ground when the golf club 10 is held in a neutral hitting position. As generally shown in FIG. 2, the sole 28 may extend from the toe portion 20 to the heel portion 22, and may smoothly transition into the hosel 24. The sole 28 may be disposed between the face 16 and a rear surface 30 of the club head 12 that is opposite the face 16.

In general, the club head 12 may be formed from metal, such as a carbon steel, that is forged or cast into shape. Following the initial rough forming, the face 16 may be ground or milled to a predefined surface finish, the plurality of grooves 18 may be cut, and any other finishing may be performed. In one embodiment, at least the face 16 may be raw-finished such that it is devoid of any surface treating such as chrome plating, anodizing, electroplating, black oxide coating, or the like. In an embodiment, the entire club head 12 may be raw-finished.

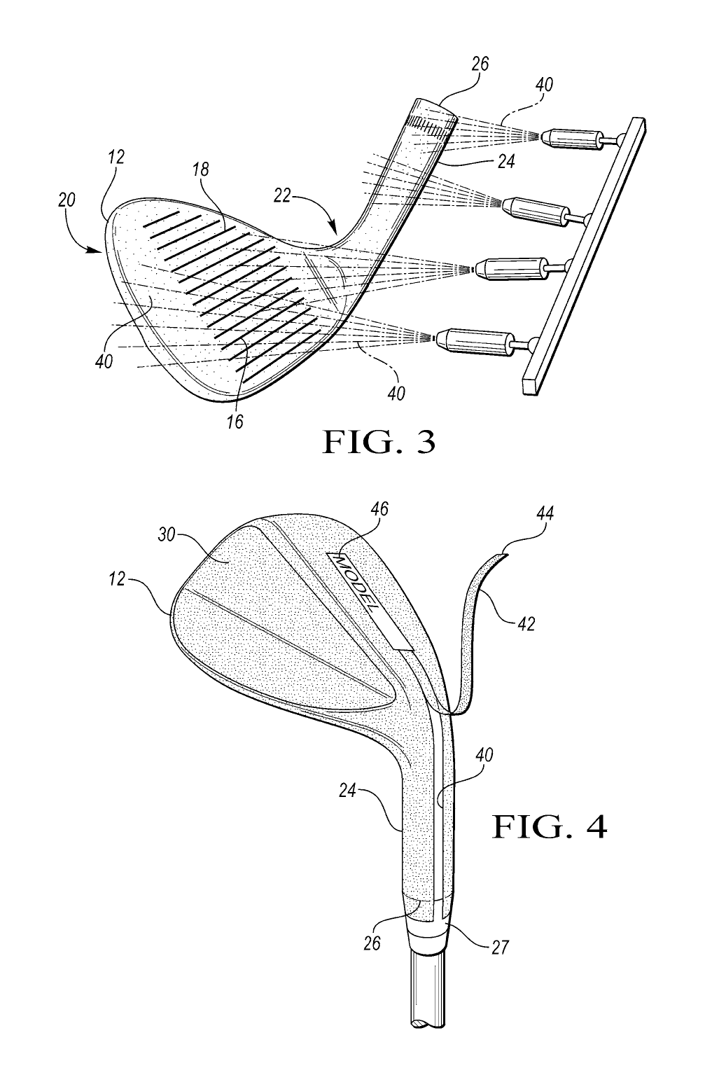

To inhibit oxidation of the untreated metal portions of the club head 12 prior to the retail sale of the golf club 10, a polymeric coating 40 may be applied to the club head 12 such as shown in FIG. 3. In one configuration, the polymeric coating 40 may be applied in a liquid form, such as by spraying an aqueous dispersion of the polymeric material directly onto the club head 12. Once evenly applied to the club head 12, the polymeric coating 40 may be dried and/or cured, such as by placing the club head in a dry environment and/or at an elevated temperature for a period of time. In a dried state, the polymeric coating 40 may form a skin on the club head 12 that may be, for example, from about 0.1 mm to about 0.4 mm thick. Due to the manner in which it is applied, the coating 40 may conform to the contours of the club head 12, and make flush contact across the entire outer surface, including on the face 16, in the grooves 18, on the rear surface 30, on the toe and heel portions 20, 22, and on the hosel 24. In one configuration, the coating 40 may entirely cover the hosel 24 and may extend onto a portion of the ferrule 27. In another configuration, the coating 40 may extend to within from about 0 mm to about 15 mm of the free end 26 of the hosel 24, rather than extending onto the ferrule 27. The present coating 40 is unlike traditional heat-shrink packaging, which does not conform to internal corners or concave surfaces and may allow air to contact the surface of the metal.

The polymeric coating 40 may be formulated such that it is capable of being easily removed from the outer surface of the club head 12 by an end user. In particular, the coating 40 may have a low molecular adhesion with the metal so that it may be easily pealable from the surface. Furthermore, to aid in removing the polymeric coating 40, a pull strip 42 may be provided between the club head 12 and the polymeric coating 40. The pull strip 42 may be a band of resilient material that is positioned, for example, along the sole 28 and hosel 24. The pull strip 42 includes a free end 44 that may extend beyond the edge of the coating 40, near the free end 26 of the hosel 24. In one configuration, the pull strip 42 may be from about 2 mm wide to about 6 mm wide, or alternatively from about 3 mm wide to about 5 mm wide.

In one configuration the pull strip 42 may include an indicia 46 that is printed on, or adhered to the strip 42. In one configuration, the indicia 46 may include a corporate logo, a brand name, or a model name. In another configuration, the indicia 46 may correspond to an attribute of the golf club head 12. In such an embodiment, the indicia 46 may identify an attribute by a numeric value, such as a loft angle, or by a qualitative indication, such as a descriptive or suggestive identifier or a trade name.

As shown in FIG. 4, to remove the polymeric coating 40, the user may lift the pull strip 42 via the free end 44 and pull in a direction away from the club head 12. Doing so may tear the coating 40 on one or both sides of the strip 42 while also stretching the surrounding coating away from the surface of the club head 12. Following this, the newly torn edges may be grabbed and used to peal the remaining portion of the coating 40 from the club head 12.

In one configuration, the polymer coating 40 may have sufficient transparency to permit any indicia provided on the club or other included branding decals to be at least partially visible through the coating 40. For example, the coating 40 may have sufficient transparency to view club head markings (e.g., a manufacturer logo, the club loft angle, or a club model name) through the dried coating 40. Likewise, the coating 40 may have sufficient transparency to view indicia 46 provided on the pull strip 42 through the dried coating 40.

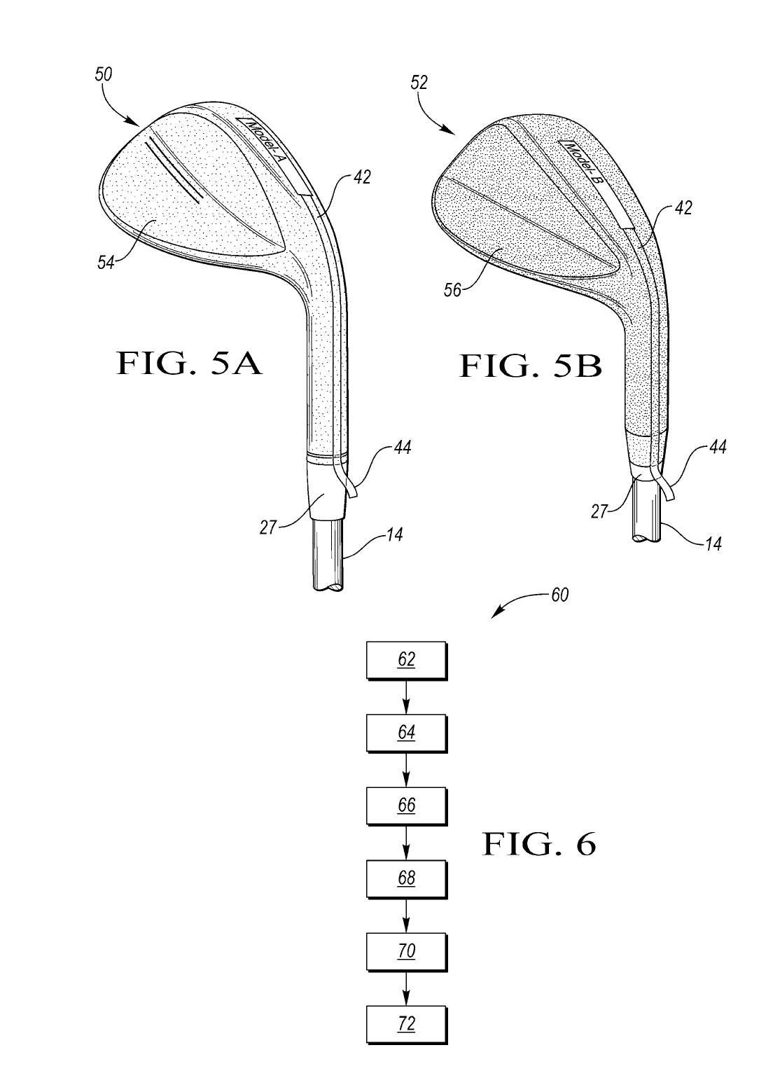

Additionally, the polymer coating 40 may be tinted or dyed to a color that corresponds to an attribute of the particular club. When used on a wedge, the coating color may be used to indicate an attribute of the club head 12 such as loft angle, sole profile, metal type, or face milling pattern. For example, FIGS. 5A and 5B illustrate two wedge club heads 50, 52 having different sole profiles. As shown, the first club head 50 may have a polymeric coating 40 of a first color 54 (illustrated generally by a first stipple pattern), and the second club head 52 may have a polymeric coating 40 of a second color 56 (illustrated generally by a second stipple pattern).

In general, the present color coating technique may be a particularly useful indicator for differing sole profiles, which do not have any universally accepted single measure. As generally understood, the sole profile of a wedge relates to at least the sole width, bounce angle (i.e., angle of the leading edge), and/or sole grind, which may all vary from toe to heal. In general, the sole profile can affect how deeply a wedge cuts into the ground for a particular swing, as well as how easily the face may be opened up without unduly altering the effective bounce angle. In this context, for example, a first color 54 may be used to indicate a sole profile that is meant for firmer ground conditions or golfers with a shallower swing, and a second color 56 may indicate a sole profile that is intended for softer ground or golfers with a steeper swing.

FIG. 6 schematically illustrates a method 60 of manufacturing a golf club head 10 that includes a removable polymeric coating indicative of at least one attribute of the golf club head 12. Such a method may be useful in preparing a plurality of clubs for a retail sale and/or for inhibiting oxidation in a raw-finished club head 12. As shown, the method 60 begins at 62 by manufacturing the golf club head 12 having at least one predefined attribute. In one configuration, the golf club head 12 may be a wedge, and the attribute may be, for example, a particular sole profile. The manufacture of the golf club at 62 may include leaving at least one raw-finished surface that is devoid of any surface treatments to inhibit oxidation (e.g., chrome plating, anodizing, black oxide coating, etc). In one configuration, the present process may be used with a plurality of golf clubs, including a first golf club head having a first attribute and a second golf club head having a second attribute (i.e., where the second attribute is different from the first attribute).

Following the manufacture of the club head 12 (or club heads), a liquid polymeric coating 40 may be selected and/or tinted at 64 such that the color of the polymeric coating 40 corresponds to the at least one predefined attribute. In one configuration, a first liquid polymeric material may be dyed a first color 54 to correspond to the first attribute, and a similar, second liquid polymeric material may be dyed a second color 56 to correspond to the second attribute. A pull strip 42 may be laid across at least a portion of the sole 28 and hosel 24 of each club head at 66, and the tinted polymeric coating 40 may be applied to the surface of the club head 12 at 68. In one configuration, the pull strip 42 may include an indicia 46 that corresponds to the attribute of the respective club head 12.

The application of the polymeric coating 40 to the surface of the club head 12 may ensure that the polymeric coating 40 contacts the entire outer surface of the club head 12 without leaving any voids. In one configuration, this step may coat the entire club head 12 and extend past a free end 26 of the hosel 24 (e.g., onto an adjoining ferrule 27). Alternatively, the coating 40 may stop from about 0 mm to about 15 mm from the free end 26 of the hosel 24. The coating 40 may be applied to the club head 12 as a liquid, such as in an aqueous dispersion. In one configuration, the application of the coating 40 may involve spraying the liquid coating onto the surface of the club head 12 using a spray nozzle and/or atomizing device.

Following the application of the liquid polymeric coating at 68, the coating 40 may be allowed to dry and/or cure at 70. This may involve heating the coating to, for example, about 100 degrees Fahrenheit to about 130 degrees Fahrenheit for about 30 to 45 minutes. Once dried, the coated club heads may be shipped and/or displayed for retail purchase at 72 together with a key that identifies the significance of each selected color coating. In one configuration, the coated club heads are shipped and/or displayed as completed golf clubs, together with a shaft 14 and grip disposed about a portion of the shaft 14.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiment. The terms “comprises,” “comprising,” “including,” and “having,” are inclusive and therefore specify the presence of stated items, but do not preclude the presence of other items. As used in this specification, the term “or” includes any and all combinations of one or more of the listed items. When the terms first, second, third, etc. are used to differentiate various items from each other, these designations are merely for convenience and do not limit the items.

1. A method of preparing a plurality of golf clubs for a retail sale, the method comprising:
providing a plurality of golf clubs including a first golf club head having a first attribute and a second golf club head having a second attribute, wherein the second attribute is different than the first attribute;
providing a first liquid polymeric material having a tint of a first color and a second liquid polymeric material having a tint of a second color;
applying the first liquid polymeric material across an outer surface of the first golf club head;
applying the second liquid polymeric material across an outer surface of the second golf club head; and
solidifying the first liquid polymeric material and the second liquid polymeric material to form a first polymeric coating across the outer surface of the first golf club head and to form a second polymeric coating across the outer surface of the second golf club head.

2. The method of claim 1, wherein the first attribute is a first sole profile and the second attribute is a second sole profile.

3. The method of claim 1, wherein applying the first liquid polymeric material includes spraying the first liquid polymeric across the outer surface of the first golf club head; and
wherein applying the second liquid polymeric material includes spraying the second liquid polymeric across the outer surface of the second golf club head.

4. The method of claim 1, wherein solidifying the first liquid polymeric material and the second liquid polymeric material includes at least one of drying or curing.

5. The method of claim 1, wherein each of the first polymeric coating and the second polymeric coating have a respective thickness of from about 0.1 mm to about 0.4 mm.

6. The method of claim 1, further comprising: providing a first polymeric strip on a surface of the first golf club head, the first polymeric strip having a free end on a hosel of the first golf club head, wherein the first liquid polymeric material is not applied to the free end of the first polymeric strip; and
providing a second polymeric strip on a surface of the second golf club head, the second polymeric strip having a free end on a hosel of the second golf club head, wherein the second liquid polymeric material is not applied to the free end of the second polymeric strip.

7. The method of claim 6, wherein providing the first polymeric strip includes placing the first polymeric strip along a portion of a sole of the first golf club head; and
wherein providing the second polymeric strip includes placing the second polymeric strip along a portion of a sole of the second golf club head.

8. The method of claim 6, wherein the first polymeric strip has a tensile strength that is greater than a tensile strength of the first polymeric coating; and
wherein the second polymeric strip has a tensile strength that is greater than a tensile strength of the second polymeric coating.

9. The method of claim 6, further comprising providing a first indicia on the first polymeric strip that corresponds to the first attribute; and
providing a second indicia on the second polymeric strip that corresponds to the second attribute.

10. The method of claim 1, further comprising packaging the plurality of golf clubs together with a key that correlates each of the first color and the second color with the respective first attribute and second attribute.

11. A method of inhibiting oxidation on a golf club comprising:
manufacturing a golf club head from a metallic material that is devoid of an oxidation-inhibiting surface treatment;
applying a polymeric material across an outer surface of the golf club head;
solidifying the polymeric material such that the polymeric material forms a coating having a thickness of from about 0.1 mm to about 0.4 mm; and
wherein there are no intermediate voids between the solidified polymeric material and the golf club head.

12. The method of claim 11, further comprising tinting the polymeric material a predetermined color; and
wherein the predetermined color corresponds to an attribute of the golf club head.

13. The method of claim 11, wherein manufacturing the golf club head includes forming the golf club head with a loft angle of from about 45 degrees to about 64 degrees.

14. The method of claim 11, further comprising applying a polymeric strip along a sole and a hosel of the golf club head prior to applying the polymeric material.

15. The method of claim 14, wherein the polymeric strip includes an indicia corresponding to an attribute of the golf club head.

16. A method of preparing a plurality of golf clubs for a retail sale, the method comprising:
providing a plurality of golf clubs including a first golf club head having a first attribute and a second golf club head having a second attribute, wherein the second attribute is different than the first attribute;
providing a first polymeric strip on a surface of the first golf club head, the first polymeric strip having a free end on a hosel of the first golf club head;
providing a second polymeric strip on a surface of the second golf club head, the second polymeric strip having a free end on a hosel of the second golf club head;
providing a first liquid polymeric material having a tint of a first color and a second liquid polymeric material having a tint of a second color;
applying the first liquid polymeric material across an outer surface of the first golf club head;
applying the second liquid polymeric material across an outer surface of the second golf club head; and
solidifying the first liquid polymeric material and the second liquid polymeric material to form a first polymeric coating across the outer surface of the first golf club head and to form a second polymeric coating across the outer surface of the second golf club head.

17. The method of claim 16, further comprising providing a first indicia on the first polymeric strip that corresponds to the first attribute; and
providing a second indicia on the second polymeric strip that corresponds to the second attribute.

18. The method of claim 16, wherein the first attribute is a first sole profile and the second attribute is a second sole profile.

19. The method of claim 16, wherein applying the first liquid polymeric material includes spraying the first liquid polymeric across the outer surface of the first golf club head and across a portion of the first polymeric strip; and
wherein applying the second liquid polymeric material includes spraying the second liquid polymeric across the outer surface of the second golf club head and across a portion of the second polymeric strip.
